(19) United States
(12) Patent Application Publication
(10) Pub. No.: US 2016/0143357 A1
(43) Pub. Date: May 26, 2016

(54) ELECTRONIC CIGARETTE SET, ELECTRONIC CIGARETTE AND BATTERY ASSEMBLY AND CHARGING STRUCTURE THEREOF

(71) Applicant: Qiuming LIU, Shenzhen, Guangdong (CN)

(72) Inventor: Qiuming LIU, Shenzhen, Guangdong (CN)

(21) Appl. No.: 14/118,296

(22) PCT Filed: Sep. 5, 2013
(86) PCT No.: PCT/CN2013/082967

§ 371 Date: Nov. 18, 2013

(30) Foreign Application Priority Data
Aug. 16, 2013 (CN) 201320503569.0

(51) Int. Cl. A24F 47/00; H02J 7/00; H05B 3/00

(52) U.S. Cl. CPC A24F 47/008; H05B 3/0014; H02J 7/0045

(57) ABSTRACT

The present application provides an electronic cigarette charging structure, two charging electrodes are formed by the center electrode arranged at the end cap of the electronic cigarette, and the battery tube with a conductive structure, such that the battery assembly may be directly inserted into the charger to be charged without disassembling an atomizing assembly, therefore the operation is more convenient, and wear and loose of a connecting portion caused by frequently assembling and disassembling may be avoided. The present application further provides an electronic cigarette with the above charging structure and a battery assembly of the electronic cigarette. The electronic cigarette is easy to charge, and also has a simple structure and is easy to manufacture since the battery tube is used directly as an electrode. An electronic cigarette set provided by the present application is convenient and practical.

This application claims the benefit of priority to Chinese patent application No. 201320503569.0 titled “ELECTRONIC CIGARETTE SET, ELECTRONIC CIGARETTE AND BATTERY ASSEMBLY AND CHARGING STRUCTURE THEREOF”, filed with the Chinese State Intellectual Property Office on Aug. 16, 2013. The entire disclosure of which is incorporated herein by reference.

### FIELD OF THE INVENTION

The present application relates to the technical field of electronic cigarettes, and particularly to an electronic cigarette set, an electronic cigarette and a battery assembly and a charging structure thereof.

### BACKGROUND OF THE INVENTION

A conventional electronic cigarette mainly includes a battery assembly and an atomizing assembly, the structure of which is shown in FIG. 1. The battery assembly includes an end cap 11, a microphone controller 12, a microphone seat 13, a battery 14, a battery sleeve 15, a spring electrode 16, an electrode fixing seat 17, and a connecting seat 18. The atomizing assembly includes a connector 20, an upper electrode 21, an upper insulating ring 22, an atomizing seat 23, an electric heating wire 24, a PVC fiberglass sleeving 25, a tar storage cotton 26, an atomizing sleeve 27, a sealing ring 28 and a mouthpiece cover 29.

Working electrodes of the electronic cigarette are located at a portion where the battery assembly and the atomizing assembly are connected, and also serve as charging electrodes. Hence when charging the battery assembly, the atomizing assembly needs to be disassembled firstly. Such structure may cause an inconvenient operation, and cause wear and loose of the connecting portion over a long period of time, which may bring a bad using experience for a user.

Therefore, in view of the above situation, a technical problem to be solved presently by those skilled in the art is to provide an electronic cigarette having an improved structure, wherein the battery assembly may be charged without disassembling an atomizing assembly, thereby facilitating the operation.

### SUMMARY OF THE INVENTION

In view of this, the present application provides a charging structure for an electronic cigarette, wherein a battery assembly may be charged without disassembling an atomizing assembly, therefore the operation is more convenient, and wear and loose of a connecting portion caused by frequently assembling and disassembling may be avoided.

The present application further provides an electronic cigarette with the charging structure, a battery assembly of the electronic cigarette and an electronic cigarette set.

For achieving the above objects, the present application provides the following technical solutions.

An electronic cigarette charging structure includes two charging electrodes arranged on an outer surface of an electronic cigarette, wherein the two charging electrodes are electrically connected to two electrodes of a battery in the electronic cigarette respectively.

Preferably, the two charging electrodes are both arranged on an outer surface of a battery assembly of the electronic cigarette.

Preferably, the two charging electrodes are both arranged on an outer circumferential surface of the battery assembly of the electronic cigarette or are both arranged at an end cap of the battery assembly.

Preferably, a first charging electrode is arranged on an end surface of the end cap and is passing through the end surface of the end cap, and the first charging electrode is electrically connected to an electrode of the battery via a microchip controller of the battery assembly; and a battery tube of the battery assembly, painted with conductive material or having an outer surface plated with metal, functions as a second charging electrode and is electrically connected to another electrode of the battery via a connecting seat of the battery assembly.

Preferably, the first charging electrode is arranged at a center of the end surface of the end cap.

Preferably, the first charging electrode is of, but not limited to, a cylindrical shape or a rectangular shape.

Preferably, a conductive spring and a printed circuit board are further arranged inside the end cap;

the printed circuit board is fixedly mounted on the end cap and is electrically connected to the microchip controller; and

the conductive spring is arranged between the first charging electrode and the printed circuit board, and is capable of providing an elastic restoring force for making the first charging electrode away from the printed circuit board.

A battery assembly of an electronic cigarette includes the above electronic cigarette charging structure.

An electronic cigarette includes a battery assembly and an atomizing assembly, wherein the battery assembly and the atomizing assembly share one common outer sleeve and the outer sleeve includes the above electronic cigarette charging structure.

An electronic cigarette set includes an electronic cigarette and a cigarette box, wherein the electronic cigarette includes the above electronic cigarette charging structure.

Preferably, a printed circuit board and a charging seat arranged on the printed circuit board are arranged in the cigarette box, the charging seat is provided to cooperate with two charging electrodes on an outer surface of the electronic cigarette, and the cigarette box functions as a charger of the electronic cigarette.

Preferably, the charging seat includes a center protruding electrode for cooperating with the first charging electrode, and a lateral elastic sheet electrode for cooperating with the second charging electrode.

As can been seen from the above technical solutions, in the electronic cigarette, the battery assembly and the electronic cigarette charging structure thereof according to the embodiment of the present application, the charging electrodes are directly arranged on the outer surface of the electronic cigarette, such that the battery assembly may be charged without disassembling an atomizing assembly, therefore the operation is more convenient, and wear and loose of a connecting portion caused by frequently assembling and disassembling may be avoided. The electronic cigarette set provided in the present application is convenient and practical.

### BRIEF DESCRIPTION OF THE DRAWINGS

For more clearly illustrating embodiments of the present application or the technical solution in the prior art, drawings referred to describe the embodiments or the prior art will be briefly described hereinafter. Apparently, the drawings in the following description are only several embodiments of the present application, and for the person skilled in the art other drawings may be obtained based on these drawings without any creative efforts.

FIG. 1 is a schematic view showing the structure of an electronic cigarette in the prior art;

FIG. 2 is a schematic view showing the structure of an electronic cigarette according to a first embodiment of the present application;

FIG. 3 is an overall view of the electronic cigarette according to the first embodiment of the present application;

FIG. 4 is an exploded view of the electronic cigarette according to the first embodiment of the present application;

FIG. 5 is a schematic view showing a charging state of the electronic cigarette according to the first embodiment of the present application;

FIG. 6 is an enlarged view showing the structure of part A in FIG. 5;

FIG. 7 is a schematic view showing the structure of an electronic cigarette according to a second embodiment of the present application;

FIG. 8 is an overall view of the electronic cigarette according to the second embodiment of the present application;

FIG. 9 is an exploded view of the electronic cigarette according to the second embodiment of the present application;

FIG. 10 is a schematic view showing the structure of an end cap according to the second embodiment of the present application;

FIG. 11 is a schematic view showing the structure of the end cap according to the second embodiment of the present application;

FIG. 12 is a schematic view showing a charging state of the electronic cigarette according to the second embodiment of the present application;

FIG. 13 is an enlarged view showing the structure of part B in FIG. 12;

FIG. 14 is a schematic view showing the structure of an electronic cigarette according to a third embodiment of the present application; and

FIG. 15 is a schematic view showing the structure of an electronic cigarette according to a fourth embodiment of the present application.

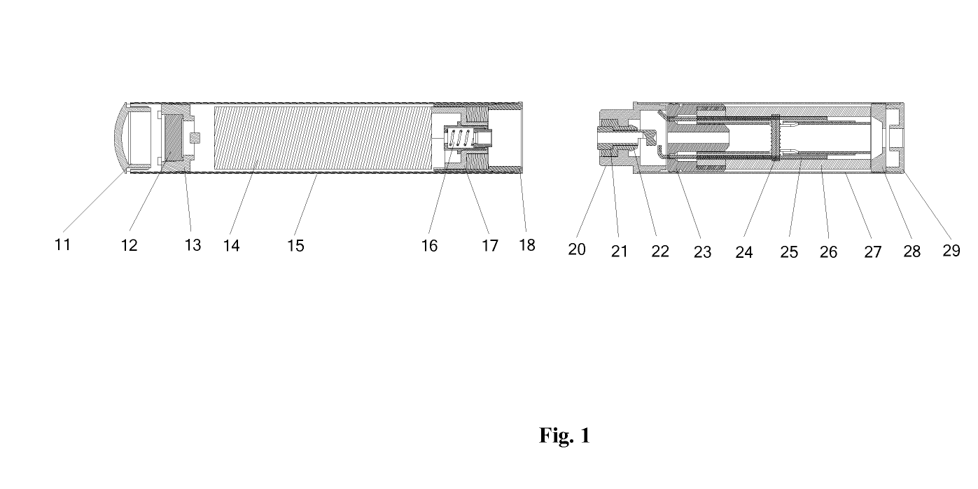

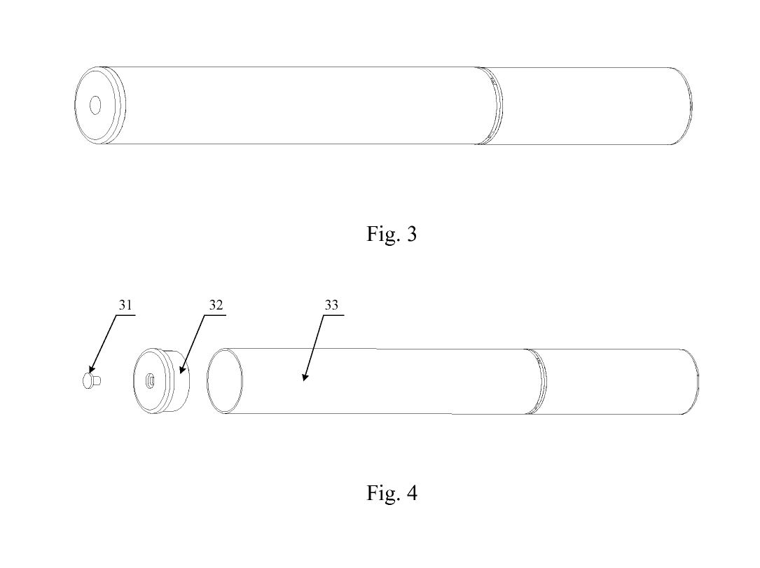

Reference numerals in FIGS. 1 to 15:

| 11 end cap, | 12 microchip controller, |
|---|---|
| 13 microchip seat, | 14 battery, |
| 15 battery sleeve, | 16 spring electrode, |
| 17 electrode fixing seat, | 18 connecting seat, |
| 20 connector, | 21 upper electrode, |
| 22 upper insulating ring, | 23 atomizing seat, |
| 24 electric heating wire, | 25 PVC fiberglass sleeving, |
| 26 tar storage cotton, | 27 atomizing sleeve, |
| 28 sealing ring, | 29 mouthpiece cover; |
| 31 first charging electrode, | 32 end cap, |
| 33 conductive battery tube, | 34 conductive spring, |
| 35 printed circuit board, | |
| 36 electrode column inserted in a battery sleeve, | |
| 37 electrode column inserted in an outer sleeve, | |
| 4 electronic cigarette, | 5 cigarette box, |
| 51 printed circuit board, and | 52 charging seat. |

### DETAILED DESCRIPTION OF THE INVENTION

The present application provides an electronic cigarette set, an electronic cigarette and a battery assembly and a charging assembly thereof, wherein the battery assembly may be charged without disassembling an atomizing assembly, therefore the operation is more convenient, and wear and loose of a connecting portion caused by frequently assembling and disassembling may be avoided. The present application is particularly advantageous in such a case that when driving a car, a driver has only one hand free to operate the electronic cigarette.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the protection scope of the present application.

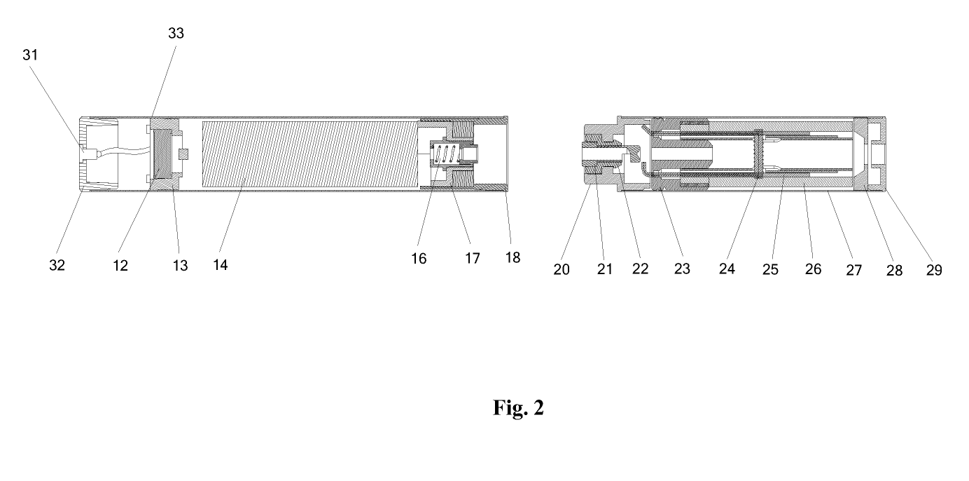

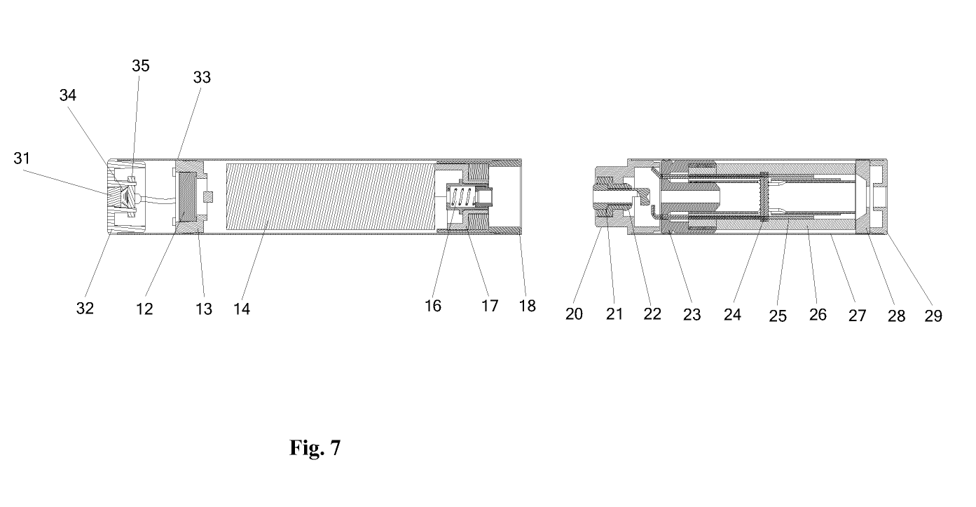

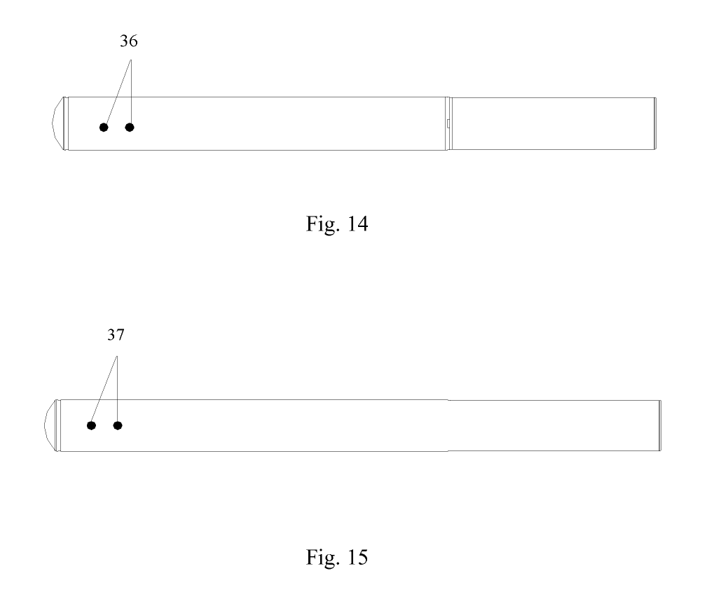

Reference is made to FIGS. 2 to 15. FIGS. 2 to 6 are views of an electronic cigarette according to a first embodiment of the present application; FIGS. 7 to 13 are views of an electronic cigarette according to a second embodiment of the present application; FIG. 14 is a schematic view showing the structure of an electronic cigarette according to a third embodiment of the present application; and FIG. 15 is a schematic view showing the structure of an electronic cigarette according to a fourth embodiment of the present application.

The electronic cigarette charging structure according to an embodiment of the present application may be applied not only in an electronic cigarette having a battery assembly and an atomizing assembly which are detachably assembled, but also in an electronic cigarette having a battery assembly and an atomizing assembly which are fixedly connected, i.e., the battery assembly and the atomizing assembly share one outer sleeve. A main improvement of the electronic cigarette charging structure lies in that, the electronic cigarette charging structure includes two charging electrodes arranged on an outer surface of the electronic cigarette, and the two charging electrodes are electrically connected to two electrodes of a battery 14 in the electronic cigarette respectively.

As can been seen from the above technical solutions, in the electronic cigarette charging structure according to the embodiment of the present application, the charging electrodes are directly arranged on the outer surface of the electronic cigarette, such that the battery assembly may be charged without disassembling an atomizing assembly, therefore the operation is more convenient, and wear and loose of a connecting portion caused by frequently assembling and disassembling may be avoided.

Since the battery 14 is arranged in the battery assembly, preferably, the two charging electrodes according to this solution are both arranged on an outer circumferential surface of the battery assembly of the electronic cigarette, or at an end cap of the battery assembly. Compared with the structure in which the charging electrodes are arranged in the atomizing assembly, this structure is simpler and requires less adjustment.

For further optimizing the above technical solutions, two charging electrodes are both arranged at an end cap 32 of the battery assembly, i.e., away from an end of the battery assembly for connecting the atomizing assembly, and the working electrode is located at this end. Due to such structure, the electronic cigarette may be charged by inserting the end, having the end cap, of the electronic cigarette directly into the charger. It should be appreciated that, the end cap 32 is referred to as a light cap when an LED light for simulating tobacco burning is arranged inside the end cap.

It should be appreciated that, the two charging electrodes according to this solution may also be arranged at other positions on the battery assembly besides the end cap, for example at a position indicated by electrode columns 36 inserted in the battery sleeve 15 as shown in FIG. 14, or may be arranged on the atomizing assembly. Appropriate adjustments can be made by the person skilled in the art according to practical requirements, which will not be described in detail herein.

According to the first embodiment of the present application, a first charging electrode 31 is arranged on an end surface of the end cap 32 and is passing through the end surface of the end cap 32, and the first charging electrode 31 is electrically connected to an electrode of the battery 14 via a microchip controller 12 of the battery assembly. A battery tube of the battery assembly functions as a second charging electrode and is electrically connected to another electrode of the battery 14 via a connecting seat 18 of the battery assembly, and the battery tube has an outer surface plated with metal or is painted with conductive material. The above structures are shown in FIGS. 2 to 4. Here, a through hole for cooperating with the first charging electrode 31 is arranged on the end surface of the end cap 32. For facilitating the cooperation with the charging seat, preferably, the end surface is modified from a conventional arc-shaped surface to a flat surface. The battery tube having the outer surface plated with metal or being painted with conductive material is a conductive battery tube 33 as shown in the Figure. Since the battery tube is directly utilized as an electrode, the whole electronic cigarette has a simple structure which may facilitate the production.

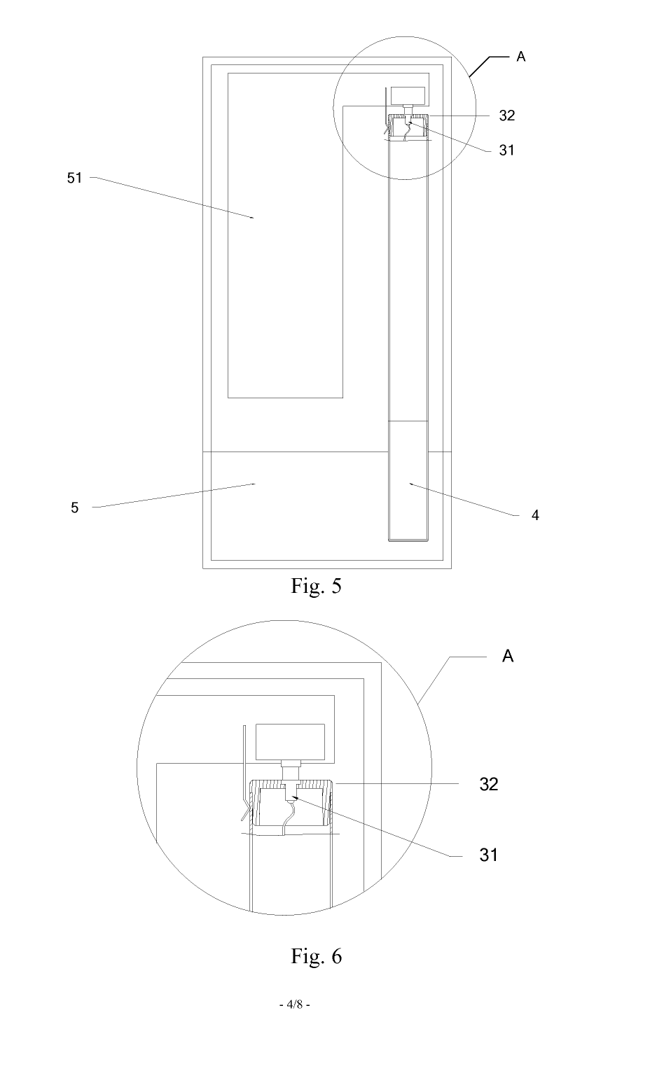

Preferably, the first charging electrode 31 is arranged at a center of the end surface of the end cap 32, such that the electronic cigarette may be inserted in a charger directly without additional aligning operation. The structure of the first charging electrode 31 in a charging state is shown in FIGS. 5 and 6.

Specifically, the first charging electrode 31 is of, but not limited to, a cylindrical shape or a rectangular shape.

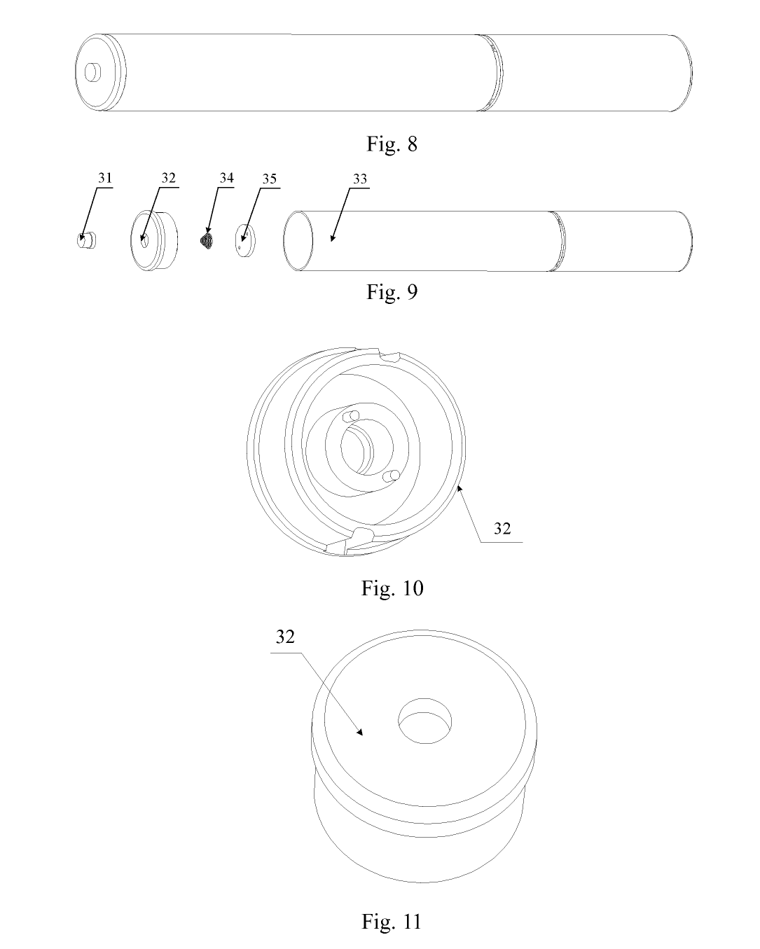

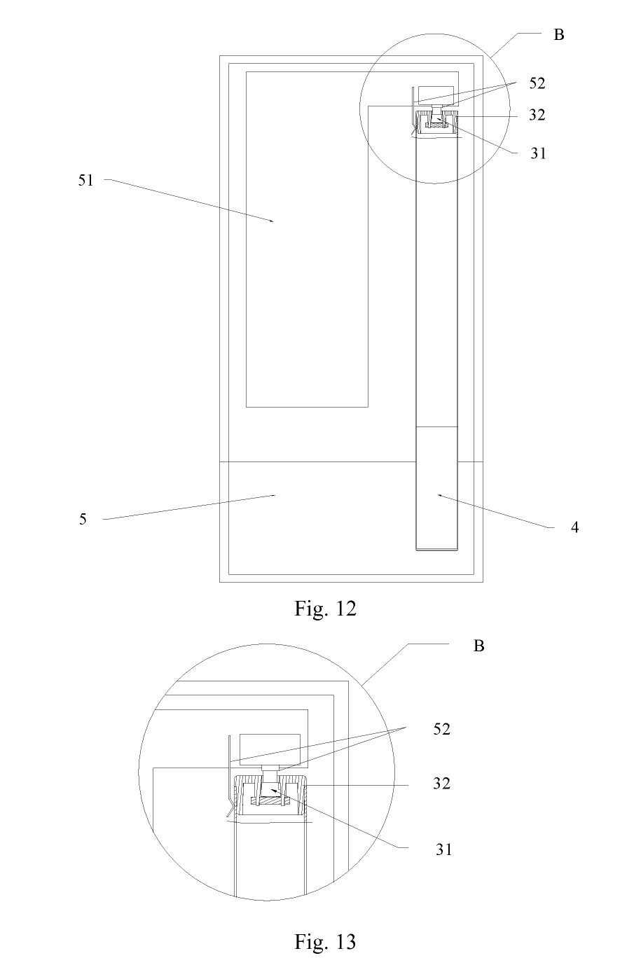

According to a second embodiment of the present application, a conductive spring 34 and a printed circuit board 35 (PCB) are further arranged inside the end cap 32. The printed circuit board 35 is fixedly mounted on the end cap 32 and is electrically connected to the microchip controller 12. The conductive spring 34 is arranged between the first charging electrode 31 and the printed circuit board 35 to provide an elastic restoring force making the first charging electrode 31 away from the printed circuit board 35. The above structure is shown in FIGS. 7 to 9. The structure of the end cap 32 in this embodiment is shown in FIGS. 10 and 11. Two mounting columns are arranged on an annular end surface, for cooperating with the printed circuit board 35, of the end cap 32, and the two mounting columns are arranged to cooperate with two mounting holes on the circular printed circuit board 35. As shown in FIGS. 12 and 13, in charging, the first charging electrode 31 located at the center is squeezed inwards by an electrode of the charger, thereby ensuring a good contact between the two electrodes.

On the basis of the above charging structure, embodiments of the present application further provide a battery assembly of an electronic cigarette, which can be cooperatively used with various kinds of atomizing assemblies, and is easy to replace.

According to a third embodiment of the present application, an electronic cigarette includes a battery assembly and an atomizing assembly which are detachably assembled, and as shown in FIG. 14, the reference number 36 denotes electrode columns inserted in the battery sleeve 15.

The charging structure in this solution may also be used in an integrated electronic cigarette, and the structure of the integrated electronic cigarette is shown in FIG. 15. According to a fourth embodiment of the present application, an electronic cigarette includes a battery assembly and an atomizing assembly which are fixedly connected, i.e., the battery assembly and the atomizing assembly share one common outer sleeve (which is different from the above detachable structure, in which the two assemblies have their own sleeve and are connected together). The outer sleeve includes the above electronic cigarette charging structure which is electrode columns 37 inserted in the outer sleeve. An embodiment of the present application further provides an electronic cigarette set including an electronic cigarette 4 and a cigarette box 5. A main improvement of the electronic cigarette set lies in that, the electronic cigarette 4 further includes the above electronic cigarette charging structure, and the battery assembly may be charged without disassembling an atomizing assembly, therefore the operation is more convenient, and wear and loose of a connecting portion caused by frequently assembling and disassembling may be avoided.

For further optimizing the above technical solutions, a printed circuit board 51 and a charging seat 52 arranged on the PCB are arranged inside the cigarette box 5, and the charging seat 52 is provided to cooperate with two charging electrodes on the outer surface of the electronic cigarette 4, therefore the cigarette box 5 may function as a charger of the electronic cigarette 4.

According to an embodiment of this solution, a slot for cooperating with the electronic cigarette 4 is arranged in the cigarette box 5, the charging seat 52 is located at a bottom of the slot. In this way, once the electronic cigarette 4 is placed back into the cigarette box 5, an end cap side of the electronic cigarette 4 may cooperate with the charging seat 52 to perform the charging.

The charging seat 52 includes a center protruding electrode for cooperating with the first charging electrode 31, and a lateral elastic sheet electrode for cooperating with the second charging electrode. It is not required to align the center electrode, thus the operation is convenient. The lateral elastic sheet electrode can ensure the stability of the electrical connection. The structure of the charging seat 52 is shown in FIGS. 5, 6, 12 and 13.

In conclusion, in the electronic cigarette charging structure according to embodiments of the present application, two charging electrodes are formed by the center electrode arranged at the end cap 32 of the electronic cigarette, and the battery tube with a conductive structure, such that the battery assembly may be directly inserted into the charger to be charged without disassembling an atomizing assembly, therefore the operation is more convenient, and wear and loose of a connecting portion caused by frequently assembling and disassembling may be avoided. The present application further provides an electronic cigarette with the above charging structure and a battery assembly of the electronic cigarette. The electronic cigarette is easy to charge, and also has a simple structure and is easy to manufacture since the battery tube is used directly as an electrode. An electronic cigarette set according to the present application is convenient and practical.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. An electronic cigarette charging structure, comprising two charging electrodes arranged on an outer surface of an electronic cigarette, wherein the two charging electrodes are electrically connected to two electrodes of a battery in the electronic cigarette respectively.

2. The electronic cigarette charging structure according to claim 1, wherein the two charging electrodes are both arranged on an outer surface of a battery assembly of the electronic cigarette.

3. The electronic cigarette charging structure according to claim 2, wherein the two charging electrodes are both arranged on an outer circumferential surface of the battery assembly of the electronic cigarette or are both arranged at an end cap of the battery assembly.

4. The electronic cigarette charging structure according to claim 3, wherein a first charging electrode is arranged on an end surface of the end cap and is passing through the end surface of the end cap, and the first charging electrode is electrically connected to an electrode of the battery via a microchip controller of the battery assembly; and a battery tube of the battery assembly, painted with conductive material or having an outer surface plated with metal, functions as a second charging electrode and is electrically connected to another electrode of the battery via a connecting seat of the battery assembly.

5. The electronic cigarette charging structure according to claim 4, wherein the first charging electrode is arranged at a center of the end surface of the end cap.

6. The electronic cigarette charging structure according to claim 5, wherein the first charging electrode is of, but not limited to, a cylindrical shape or a rectangular shape.

7. The electronic cigarette charging structure according to claim 4, wherein a conductive spring and a printed circuit board are further arranged inside the end cap;
the printed circuit board is fixedly mounted on the end cap and is electrically connected to the microchip controller; and
the conductive spring is arranged between the first charging electrode and the printed circuit board, and is capable of providing an elastic restoring force for making the first charging electrode away from the printed circuit board.

8. A battery assembly of an electronic cigarette, comprising the electronic cigarette charging structure according to claim 1.

9. An electronic cigarette, comprising a battery assembly and an atomizing assembly, wherein the battery assembly and the atomizing assembly share one common outer sleeve and the outer sleeve comprises the electronic cigarette charging structure according to claim 1.

10. An electronic cigarette set, comprising an electronic cigarette and a cigarette box, wherein the electronic cigarette comprises the electronic cigarette charging structure according to claim 1.

11. The electronic cigarette set according to claim 10, wherein a printed circuit board and a charging seat arranged on the printed circuit board are arranged in the cigarette box, the charging seat is provided to cooperate with two charging electrodes on an outer surface of the electronic cigarette, and the cigarette box functions as a charger of the electronic cigarette.

12. The electronic cigarette set according to claim 11, wherein the charging seat comprises a center protruding electrode for cooperating with the first charging electrode, and a lateral elastic sheet electrode for cooperating with the second charging electrode.

13. The electronic cigarette charging structure according to claim 5, wherein a conductive spring and a printed circuit board are further arranged inside the end cap;
the printed circuit board is fixedly mounted on the end cap and is electrically connected to the microchip controller; and
the conductive spring is arranged between the first charging electrode and the printed circuit board, and is capable of providing an elastic restoring force for making the first charging electrode away from the printed circuit board.

14. The electronic cigarette charging structure according to claim 6, wherein a conductive spring and a printed circuit board are further arranged inside the end cap;
the printed circuit board is fixedly mounted on the end cap and is electrically connected to the microchip controller; and
the conductive spring is arranged between the first charging electrode and the printed circuit board, and is capable of providing an elastic restoring force for making the first charging electrode away from the printed circuit board.
